(19) United States
(12) Patent Application Publication
(10) Pub. No.: US 2006/0089224 A1
(43) Pub. Date: Apr. 27, 2006

(54) Power transmission device

(75) Inventors: Michiyasu Nosaka, Anjo-city (JP); Yasuo Tabuchi, Toyoake-city (JP); Motohiko Ueda, Okazaki-city (JP); Yoshiki Tada, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/248,264

(22) Filed: Oct. 13, 2005

(30) Foreign Application Priority Data
Oct. 21, 2004 (JP) 2004-306532

(51) Int. Cl. F16H 55/49; F16H 55/36; F16H 63/00

(52) U.S. Cl. 474/170; 474/199; 474/70

(57) ABSTRACT

A power transmission device comprises: a pulley 1 pivotally arranged in a casing 9; a hub fixed to a rotary shaft 8; and a torque limiter, having a torque limiting function, for transmitting power between the pulley and the hub and shutting off the transmission of power by breaking a power transmission path in the case where an excessively heavy load is given to the power transmission device. The power transmission device further comprises: a cylindrical member 7 engaged with and fixed to the rotary shaft 8 so that the cylindrical member 7 can be contacted with a hub seating surface 4d; and a seating portion 9c for receiving the cylindrical member, formed in the casing, wherein a gap G is formed between a contact face 7e at the rear end of the cylindrical member and a contact face 9d of the seating portion 9c.

### BACKGROUND OF THE INVENTION

1. Technical Field of the Invention

The present invention relates to a power transmission device having a torque limiting function. More particularly, the present invention relates to a power transmission device preferably used for a compressor incorporated into an air conditioner for vehicle use.

2. Description of the Related Art

In a conventional power transmission device used for transmitting power to a compressor, a fastening structure for fastening a rotary shaft to a hub, in which the fastening is accomplished by means of screwing, is usually employed. That is, a screw portion, which is formed on an outer circumferential face of a forward end portion of the rotary shaft, and a screw portion, which is formed on an inner circumferential face of the hub, are screwed to each other. In this structure, in order to restrict an amount of screwing the rotary shaft into the hub, a seating surface (a step portion) is formed at a position, an the rotary shaft, adjacent to the screw portion. When a forward end face of the cylindrical portion of the hub comes into pressure contact with the seating surface of the rotary shaft, the hub and the rotary shaft are fastened and fixed to each other and are capable of transmitting power. Accordingly, the contact face, at which the forward end face of the cylindrical portion of the hub and the seating surface of the rotary shaft are contacted with each other, becomes a power transmitting face.

Therefore, in order to ensure power transmission, it is necessary to extend the area of this contact face. However, extending the contact face is the same as extending the area of the seating face, which necessarily makes the diameter of the rotary shaft large, that is, which makes the size of the compressor large.

Therefore, according to the fastening structure disclosed in the official gazette of JP-A-2003-35255, as shown in FIG. 5, the cylindrical member A is press-fitted and fixed to the rotary shaft B and this cylindrical member A is made to come into contact with the cylindrical portion of the hub C. Due to this structure, without increasing the diameter of the rotary shaft, the contact face can be made large, so that power can be positively transmitted.

In the fastening structure disclosed in the official gazette of JP-A-2003-35255, an axial force in the axial direction of the rotary shaft B and the screw fastening portion of the hub C, which is generated by the power transmission torque at the time of the normal air conditioning operation of the compressor, is held by a press-fitted fixing portion of the cylindrical member A. Therefore, the following problems may be encountered. When the compressor is seized, the torque given to the compressor is increased, and an axial force, which is higher than that of the torque at the time of the normal air conditioning operation, is given to this screw fastening portion, and this press-fitted fixing portion is press-fitted more.

At the time of the seizure of the compressor, even when a torque higher than that in the normal air conditioning operation is generated, it is impossible for the torque limiter D to be given a predetermined intensity of torque which is set in the torque limiter because the press-fitting is caused more as described above.

Further, the following problems may be encountered. When press-fitting is caused more as described above, the hub C described in the official gazette of JP-A-2003-35255 is pressed in the direction of the pulley E by the screw engagement, and a thrust load is given to the bearing F, which greatly deteriorates the durability of the bearing. In the case where an elastic material member is interposed between the pulley E and the hub C, the pulley E and the hub C interfere with each other, which causes problems such as a smoke generation.

### SUMMARY OF THE INVENTION

The present invention has been accomplished to solve the above problems. It is an object of the present invention to provide a power transmission device having a torque limiter capable of operating at a predetermined torque when a compressor suffers seizure.

The power transmission device of the present invention comprises: a pulley rotatably arranged in a casing; a hub screwed and fixed to a forward end portion of a rotary shaft; and a torque limiter, having a torque limiting function, for transmitting power between the pulley and the hub and shutting off the transmission of power, by breaking a portion of a power transmission path, when an excessively heavy load is given to the power transmission device, and the power transmission device further comprises: a cylindrical member engaged with and fixed to the rotary shaft so that the cylindrical member can be contacted with a hub seating surface which is a rear face of the hub; and a seating portion for receiving the cylindrical member, formed in the casing, wherein a gap is formed between a contact face at the rear end of the cylindrical member and a contact face of the seating portion. Due to the above structure, when the torque is increased due to the seizure of the compressor, the cylindrical member is moved by a distance of the gap while being plastically deformed, and the cylindrical member comes into contact with the contact face of the seating portion and an excessively high axial force is recovered. Therefore, the power transmission device can be operated at a predetermined torque until the power transmission path of the rotary shaft is shut off, by the torque limiter, at the broken portion.

According to the power transmission device of the present invention, the cylindrical member is made of material which is plastically deformed by an axial force stronger than an axial force generated by the maximum torque generated at the time of normal operation of a compressor.

According to the power transmission device of the present invention, a step portion having a tapered portion is formed on an inner circumferential face of the cylindrical member and a step portion having a tapered portion is formed on an outer circumferential face of the rotary shaft. When both the tapered portions are contacted with each other, the cylindrical member can be engaged with and fixed to the rotary shaft while being positioned at a predetermined position of the rotary shaft. Accordingly, when the compressor is out of order, the tapered portion of the cylindrical member is plastically deformed.

According to the power transmission device of the present invention, a step face is formed on an inner circumferential face of the cylindrical member and a step face is also formed on an outer circumferential face of the rotary shaft. When both the step faces are contacted with each other, the cylindrical member is engaged with and fixed to the rotary shaft while being positioned at a predetermined position of the rotary shaft. Accordingly, when the compressor is out of order, the step face of the cylindrical member is plastically deformed.

According to the power transmission device of the present invention, a cutout portion is formed in a root portion of the step face of the cylindrical member. Due to this structure, when the compressor is out of order, the step face of the cylindrical member is easily broken. Therefore, the cylindrical member can be smoothly and plastically deformed.

According to the power transmission device of the present invention, the cylindrical member is engaged with, and fixed to, the rotary shaft by means of press-fitting. Accordingly, the cylindrical member can be firmly fixed to the rotary shaft.

According to the power transmission device of the present invention, the rotary shaft is given a torque limiting function. Therefore, the rotary shaft is broken at a breaking portion (a torque limiter) when an excessively high torque is given.

According to the power transmission device of the present invention, the seating portion of the casing is formed in a manner so that a different annular seating portion is fixed to the casing by a snap ring. Due to this structure, the gap can be accurately formed.

The present invention may be more fully understood from the description of preferred embodiments of the invention, as set forth below, together with the accompanying drawings.

### BRIEF DESCRIPTION OF THE DRAWINGS

In the drawings:

FIG. 1 is a sectional view showing an upper half of the power transmission device of the first embodiment of the present invention;

FIG. 2 is an enlarged sectional view showing a primary portion of the power transmission device of the first embodiment;

FIGS. 3A to 3D are views for explaining the behavior of the power transmission device in the case where the compressor seizes;

FIGS. 4A to 4E are enlarged sectional views respectively showing primary portions of the power transmission devices of the second to the sixth embodiment; and

FIG. 5 is a sectional view showing a conventional power transmission device.

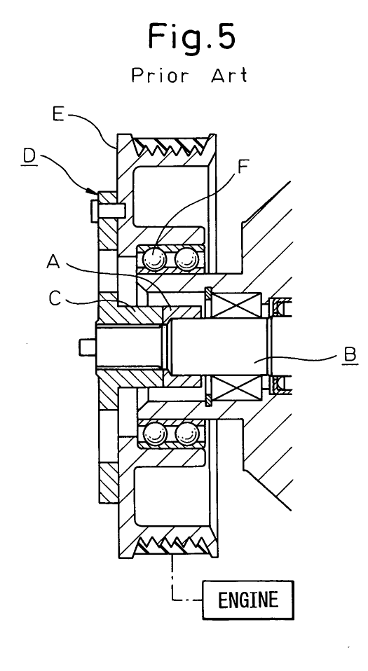

### DESCRIPTION OF THE PREFERRED EMBODIMENTS

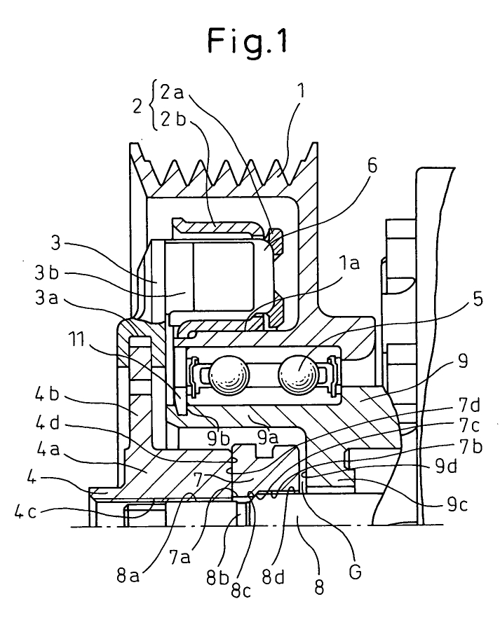

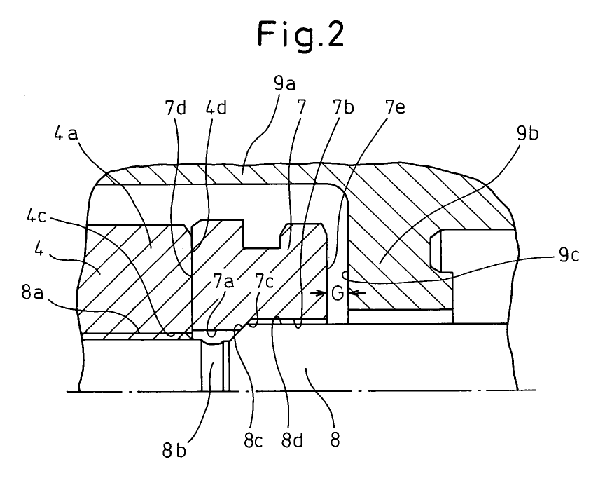

Referring to the accompanying drawings, a power transmission device of the embodiment of the present invention will be explained below. The power transmission device of the present invention is preferably incorporated into a compressor of an air conditioner for vehicle use which is driven by an engine or motor. FIG. 1 is a sectional view showing an upper half of the power transmission device of the first embodiment of the present invention. FIG. 2 is an enlarged sectional view of a primary portion of the power transmission device as shown in FIG. 1. The power transmission device of the present invention transmits power (torque) between the pulley 1, which is a drive side rotating member for obtaining a driving force from an engine or motor, and the hubs 3, 4 composed of the first hub 4 and the second hub 3 which are rotary members on the driven side fixed to the rotary shaft 8 of the compressor. The pulley 1 and the hubs 3, 4 are arranged on the same shaft.

The pulley 1 is rotatably attached to the cylindrical portion 9a, which is provided on one end side of the casing 9 of the compressor, via the bearing device 5. A belt (not shown) is wound round the outer circumferential face of the pulley 1, and the pulley 1 is rotated being driven by an external force generated by an engine or motor. The bearing device 5 is engaged with the cylindrical portion 9a and is prevented from moving in the axial direction by the snap ring 11 embedded in the groove 9b formed on the outer circumferential face of the cylindrical portion 9a. A portion between the casing 9 and the rotary shaft 8 of the compressor is tightly sealed by a shaft seal device (not shown), so that the refrigerant and the lubricating oil are prevented from leaking out.

On the front side (the left in FIG. 1) of the pulley 1, in order to connect with the hub described later, a ring-shaped recess portion 1a is formed which receives the annular cup 2 so that the annular cup 2 can be mounted in the ring-shaped recess portion 1a. The annular cup 2 includes: a ring-shaped cup plate 2a; and a plurality of cup rings 2b which are attached to the cup plate 2a. A plurality of cup rings 2b, for example, six cup rings 2b are attached to the cup plate 2a at regular intervals in the circumferential direction. It is preferable that an annular cup 2 is made of a metal such as iron and is attached to the circumferential face inside the recess portion 1a of the pulley 1 by means of welding or press-fitting.

The rotary shaft 8 of the compressor includes: a screw portion 8a, a torque limiter portion 8b, a tapered portion 8c and a shaft outer diameter portion 8d which are arranged in this order from the front side (the left in FIG. 1). The screw portion 8a, which is a forward end portion of the rotary shaft 8, is protruded from the casing 9, and the diameter of the screw portion 8a is formed a little smaller than that of the shaft outer diameter portion 8d. On the outer circumference of the screw portion 8a, an external screw is formed. The diameter of the torque limiter portion 8b is smaller than that of the screw portion 8a. When an excessively high axial force is given to the screw portion 8a, this torque limiter portion 8b is broken. The tapered portion 8c is a transition portion between the torque limiter portion 8b and the shaft outer diameter portion 8d, the diameter of which is a little larger than that of the screw portion 8a. This tapered portion 8c is an inclined face which obliquely rises to the right as shown in FIGS. 1 and 2.

The hubs 3, 4 are composed of the first hub 4 and the second hub 3. The first hub 4 includes: a cylindrical boss portion 4a; and a disk-shaped protruding portion 4b protruding in the radial direction from the outer circumferential face of the boss portion 4a. On the inner circumferential face of the boss portion 4a, an internal screw is provided, which forms the screw portion 4c. Therefore, when the boss portion 4a of the first hub 4 is screwed into the rotary shaft 8, the screw portion 4c of the boss portion 4a and the screw portion 8a of the rotary shaft 8 are joined to each other by means of screwing. The second hub 3 is a disk-shaped plate, on the inner circumferential face of which the groove 3a for receiving an end portion of the protruding portion 4b of the first hub 3 is formed. Further, on the rear face (on the right in FIG. 1) of the second hub 3, the protrusions 3b, the number of which is the same as that of the cup rings 2b, are formed at regular intervals. In this case, it is preferable that the first hub 4 is made of a metal such as iron and that the second hub 3 is made of resin. When the first hub 4 and the second hub 3 are integrated with each other into one body by means of engagement joining or insertion forming in this way, the hubs 3, 4 are formed.

The cup-shaped elastic members 6 for torque transmission are fitted to the protrusions 3b of the second hub 3. Further, these elastic members 6 are press-fitted into the cup rings 2b of the annular cup 2. Due to the foregoing, the second hub 3 and the annular cups 2, that is, the hubs 3, 4 and the pulley 1 are connected to each other via the elastic member 6.

The characteristic portions of the present invention will be explained below. In the cylindrical portion 9a of the casing 9 to which the pulley 1 is attached, the annular seating portion 9c, which protrudes from the inner circumferential face, inward, in the radial direction, is formed. The first hub 4 is screwed to the rotary shaft 8, and the cylindrical member 7 is engaged with and fixed to the rotary shaft 8. Accordingly, the cylindrical member 7 is received in a space formed by the cylindrical portion 9a of the casing 9 and the seating portion 9c. This cylindrical member 7 is arranged on the rotary shaft 8 so that the hub seating face 4d, which is a rear face of the boss portion 4a of the first hub 4, and the seating face 7d, which is a front face of the cylindrical member 7, can contact each other. The inner circumferential face of the cylindrical member 7 includes: a small diameter inner circumferential face 7a; a large diameter inner circumferential face 7b; and a tapered portion (a tapered face) 7c formed between the small diameter inner circumferential face 7a and the large diameter inner circumferential face 7b. When the tapered portion 7c of this cylindrical member 7 comes into contact with the tapered portion 8c of the rotary shaft 8, the cylindrical member 7 can be positioned at a predetermined position on the rotary shaft 8. Accordingly, both the tapered portions 7c, 8c are inclined by the same angle. In this embodiment, the inner diameter of the large diameter inner circumferential face 7b of the cylindrical member 7 is a little larger than the outer diameter of the shaft outer diameter portion 8d of the rotary shaft 8.

Further, when the cylindrical member 7 is positioned at a predetermined position on the rotary shaft 8, a predetermined gap G, the size of which is predetermined, is formed between the contact face 7e, which is a rear face of the cylindrical member 7, and the contact face 9d which is a front face of the seating portion 9c of the casing 9. This gap G allows a movement of the cylindrical member 7 when the cylindrical member 7 is plastically deformed.

The material of the cylindrical member 7 and the shape of the tapered portion 7c are determined so that the material can yield and be plastically deformed when a predetermined load is given to the cylindrical member 7. However, the material of the cylindrical member 7 and the shape of the tapered portion 7c are determined so that such a plastic deformation as a sinkage cannot be caused when an axial force generated by the maximum torque in the normal operation of the compressor is given to the cylindrical member 7.

The thus composed power transmission device is operated as follows.

External power generated by an engine not shown is transmitted to the pulley 1 via a belt (not shown). Power is transmitted from the pulley 1 to the second hub 3 and the first hub 4 via the elastic member 6. The first hub 4 is provided with the screw portion 4c and engaged with the rotary shaft 8 of the compressor by means of screwing. As the diameter of the shaft outer diameter portion 8d of the rotary shaft 8 is approximately the same as the diameter of the screw portion 8a of the rotary shaft 8, an axial force generated by the torque in this fastening portion at the time of operating the compressor is restricted by the tapered portion 7c of the cylindrical member 7. In this way, the compressor is operated in the normal air conditioning operation.

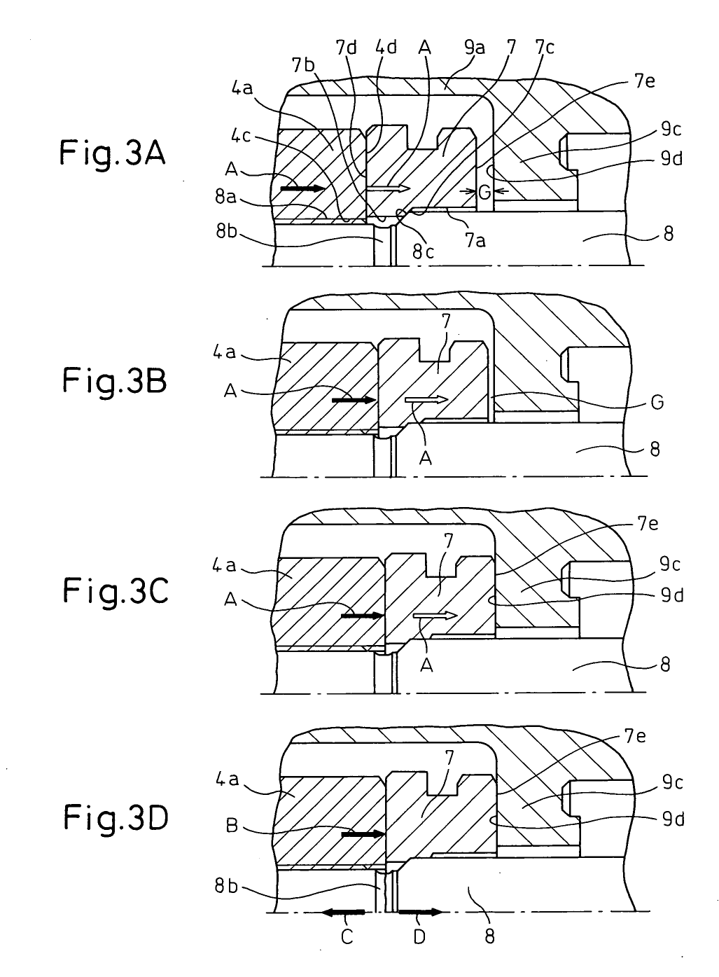

FIGS. 3A to 3D are views for explaining states from the seizure of the compressor to the operation of the torque limiter. FIG. 3A shows a relation of the force given to the fastening portion, in which the first hub 4 and the rotary shaft 8 are screwed to each other, in the normal air conditioning operation. In order to operate the compressor, torque is given by the pulley 1 to the hubs (the first hub 4 and the second hub 3). In this fastening portion, the axial force A is generated by the torque. This axial force A pushes the cylindrical member 7 to the right as shown by the white arrow in FIG. 3A. As the cylindrical member 7 is provided with the tapered portion 7c and the rotary shaft 8 is also provided with the tapered portion 8c, the axial force A is received by this tapered portion 8c.

A movement of the cylindrical member 7 at the time of the seizure of the compressor in this state is shown in FIGS. 3B to 3D. In the case where the compressor has seized, however, a rise in the torque caused by the seizure of the compressor is lower than the operation torque of the torque limiter portion 8b provided in the device, the tapered portion 7c of the cylindrical member 7 is plastically deformed by the rise in the torque caused by the seizure as shown in FIG. 3B. When this plastic deformation of the tapered portion 7c of the cylindrical member 7 is caused, while the cylindrical member 7 is being pressed to the right by the boss portion 4a of the first hub 4, the cylindrical member 7 starts to move along the rotary shaft 8, and the gap G is further reduced.

However, as shown in FIG. 3C, the cylindrical member 7 is moved only by the size of the gap G which has been previously set, and the contact face 7d of the cylindrical member 7 comes into contact with the contact face 9d of the seating portion 9c of the casing 9. When the cylindrical member 7 has moved to the seating portion 9c of the casing 9, an intensity of torque is increased by the screw engaging portion between the first hub 4 and the rotary shaft 8. Accordingly, as shown in FIG. 3D, an excessively high axial force B is recovered in the screw engaging portion. As the torque limiter portion 8b is provided on the rotary shaft 8, the torque limiter portion 8b on the rotary shaft 8 is broken by the reciprocal loads C, D generated in the torque limiter portion 8b by this excessively high axial force B. Accordingly, the power transmission is shut off.

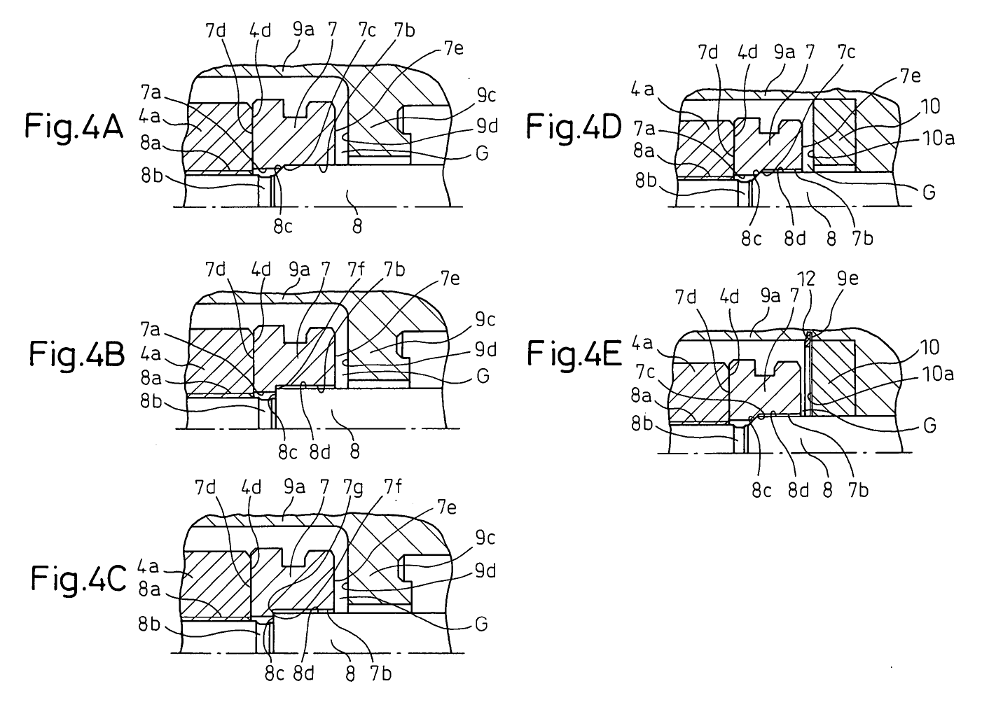

FIGS. 4A to 4E are sectional views showing primary portions of the power transmission devices of the embodiments which are different from each other. In the second embodiment shown in FIG. 4A, the inner diameter of the large diameter inner circumferential face 7b of the cylindrical member 7 is made to be the same as the outer diameter of the shaft outer diameter portion 8d of the rotary shaft 8. Alternatively, the inner diameter of the large diameter inner circumferential face 7b of the cylindrical member 7 is made to be a little smaller than the outer diameter of the shaft outer diameter portion 8d of the rotary shaft 8. Accordingly, the cylindrical member 7 is press-fitted and fixed to the rotary shaft 8 at a position where both the tapered portions 7c, 8c are contacted with each other. The other points of the structure are the same as those of the first embodiment. Therefore, explanations are omitted here.

In the third embodiment shown in FIG. 4B, instead of the tapered portion 7c, the step-shaped step face (the shoulder portion) 7f is formed on the inner circumferential face of the cylindrical member 7. In the same manner, instead of the tapered portion 8c, the step-shaped step face (the shoulder portion) 8e is formed on the rotary shaft 8. Accordingly, the cylindrical member 7 is inserted into a position, on the rotary shaft 8, at which both the step faces 7f, 8e are contacted with each other, and is fixed to the rotary shaft 8. The other points of the structure are the same as those of the first embodiment. Therefore, explanations are omitted here.

In the fourth embodiment shown in FIG. 4C, the cutout portion 7g is formed in the root portion of the step-shaped step face 7f formed on the inner circumferential face of the cylindrical member 7 of the third embodiment. Due to this structure, when the cylindrical member 7 is given the axial force A, the step face 7f can be easily broken. The other points of the structure are the same as those of the third embodiment. Therefore, the explanations are omitted here.

FIG. 4D is a view showing the fifth embodiment. In the first embodiment, the seating portion 9c is formed integrally with the casing 9. However, in this fifth embodiment, the seating portion is provided as a different seating portion 10 which is provided differently from the casing 9. The different seating portion 10 is annular, and the outer diameter of the different seating portion 10 is a little larger than the inner diameter of the cylindrical portion 9a of the casing 9. Accordingly, when the different seating portion 10 is press-fitted into the cylindrical portion 9a, the different seating portion 10 is engaged with and fixed to a predetermined position. The end face on the front side (on the left in FIG. 4D) of this different seating portion 10 becomes a contact face 10a with the cylindrical member 7. Of course, the gap G is formed between the contact face 7e of the cylindrical member 7 and the contact face 10a of the different seating portion 10. The other points of the structure are the same as those of the first embodiment. Therefore, explanations are omitted here.

In the sixth embodiment shown in FIG. 4E, instead of the fixing by the press-fitting engagement of the different seating portion 10 of the fifth embodiment, the different seating portion 10 is fixed by the snap ring 12 engaged with the groove 9e formed on the inner circumferential face of the cylindrical portion 9a of the casing 9. The other points of the structure are the same as those of the fifth embodiment. Therefore, explanations are omitted here.

In this connection, in this embodiment, explanations are made into the structure of the torque limiter in which the torque limiter portion is arranged on the rotary shaft. However, it should be noted that the same effect as that of the present invention can be provided even when the torque limiter portion is provided at a portion other than the rotary shaft.

As explained above, according to the present invention, the cylindrical member, made of material the mechanical strength of which is higher than a predetermined value, is set on the rotary shaft of the compressor, and the seating portion is provided inside the casing on the compressor side and a predetermined gap is formed between the cylindrical member and the seating portion of the casing. Due to the above structure, in the case of the engagement with the rotary shaft of the compressor, the diameter of which is a little larger than the size of the screw engagement of the hub with the rotary shaft, it is possible to provide a power transmission device having a torque limiter capable of being operated at a predetermined torque.

While the invention has been described by reference to specific embodiments chosen for purposes of illustration, it should be apparent that numerous modifications could be made thereto, by those skilled in the art, without departing from the basic concept and scope of the invention.

1. A power transmission device comprising:
a pulley rotatably arranged in a casing;
a hub screwed and fixed to a forward end portion of a rotary shaft; and
a torque limiter, having a torque limiting function, for transmitting power between the pulley and the hub and shutting off the transmission of power by breaking a portion of a power transmission path when an excessively heavy load is given to the power transmission device,
the power transmission device further comprising:
a cylindrical member engaged with and fixed to the rotary shaft so that the cylindrical member can be contacted with a hub seating surface which is a rear face of the hub; and
a seating portion for receiving the cylindrical member, formed in the casing, wherein
a gap is formed between a contact face at the rear end of the cylindrical member and a contact face of the seating portion.

2. A power transmission device according to claim 1, wherein the cylindrical member is made of material which is plastically deformed by an axial force stronger than an axial force generated by the maximum torque generated at the time of normal operation of a compressor.

3. A power transmission device according to claim 1, wherein a step portion having a tapered portion is formed on an inner circumferential face of the cylindrical member, a step portion having a tapered portion is formed in the same manner at a position on the outer circumferential face of the rotary shaft where the cylindrical member is engaged and fixed, and when the cylindrical member is engaged with the rotary shaft, both the tapered portions are contacted with each other so that the cylindrical member can be positioned on the rotary shaft.

4. A power transmission device according to claim 1, wherein a step-shaped step face is formed on an inner circumferential face of the cylindrical member, a step-shaped step face is formed in the same manner at a position on the outer circumferential face of the rotary shaft where the cylindrical member is engaged and fixed, and when the cylindrical member is engaged with the rotary shaft, both the step faces are contacted with each other so that the cylindrical member can be positioned on the rotary shaft.

5. A power transmission device according to claim 4, wherein a cutout portion is formed in a root portion of the step-shaped step face of the cylindrical member.

6. A power transmission device according to claim 1, wherein the cylindrical member is engaged with and fixed to the rotary shaft being press-fitted.

7. A power transmission device according to claim 1, wherein the torque limiting function is provided on the rotary shaft.

8. A power transmission device according to claim 1, wherein the seating portion is formed when an annular different seating portion is fixed to the casing with a snap ring.
